(19) United States
(12) Patent Application Publication
(10) Pub. No.: US 2008/0004833 A1
(43) Pub. Date: Jan. 3, 2008

(54) Method for the Nondestructive Determination of the Inner Dimensions and/or the Outer Dimensions of a Shoe and/or of a Last

(76) Inventor: Norbert L. Becker, Tuebingen (DE)

Correspondence Address: MORRISON & FOERSTER LLP, 12531 HIGH BLUFF DRIVE, SUITE 100, SAN DIEGO, CA, 92130-2040, US

(21) Appl. No.: 11/579,971

(22) PCT Filed: May 3, 2005
(86) PCT No.: PCT/DE05/00831

§ 371 Date: Sep. 7, 2007

(30) Foreign Application Priority Data
May 8, 2004 (DE) 20 2004 007 398.6

(51) Int. Cl. G01B 15/00; A43D 1/02; G01N 23/04

(52) U.S. Cl. 702/156; 702/172

(57) ABSTRACT

The method serves for the nondestructive determination of all or particular selected inner dimensions and/or outer dimensions of a shoe, boot or the like and/or the outer dimensions of a last that is used to make a shoe. To this end, use is made of a measuring arrangement which detects and/or images the inner area of the shoe and/or the surface of the last in three dimensions and is used by a radiological, computer tomographic, NMR tomographic or other imaging measurement method, which penetrates the sole and upper of the shoe and scans the surface of the last, to determine and store cross-sectional images in layers. After this, the cross-sectional images are used to determine typical fixed points or virtual points, which are based on the shape of the foot, and connecting lines which extend between said points and can run in the plane of the sectional images or else in any desired orientation with respect to the latter. However, use may also be made of an X-ray recording method whose summation pictures are used by an X-ray contrasting calibration element to measure the points of interest.

### TECHNICAL FIELD

The invention relates to a method for the nondestructive determination of all or particular selected inner dimensions and/or outer dimensions of a shoe, boot or the like and/or the outer dimensions of a last that is used to make a shoe.

### BACKGROUND ART

Shoes are usually manufactured using a last, with the result that the shoe then has the shape prescribed by the last in terms of all of its dimensions.

The process of removing the last from the shoe is also followed by processes which result in a change in the shape or size, generally in shrinkage of the shoe material. This results in the dimensions prescribed by the last no longer matching those of the shoe itself. The prized dimensions such as length, breadth, width, height and volume thus no longer correspond to those prescribed by the last.

If the extent of the shrinkage process is known, the last used to manufacture the shoe can be correspondingly adapted so that the shoe has the desired dimensions after the shrinkage process.

On the other hand, the inner dimensions of a shoe also change during wear since the shoe material is deformed by the pressure caused by the foot.

### DISCLOSURE OF THE INVENTION

The prior art discloses different measurement methods for measuring the interior both of new shoes and of used shoes. For example, templates containing units of measurement are thus inserted into the shoe, circumferential measurements are carried out using knurled screws and springs or telescopic rules are inserted into the shoe in order to monitor and measure the inner dimensions of the shoe.

However, these measurement methods are inaccurate and difficult to carry out and, in addition, generally do not do justice to the shape of the interior of the foot and have greater measurement errors, the smaller the shoe.

Therefore, the invention is based on the object of developing a measurement system which measures both the new shoe and used shoe with and without the last in a nondestructive manner and provides accurate data on the inner dimensions of the shoe.

A method which achieves this object is characterized by a measuring arrangement which detects and/or images the inner area and/or outer area of the shoe and/or the surface of the last in three dimensions and is used by a radiological, computer tomographic, NMR tomographic or other imaging measurement method, which penetrates the sole and upper and scans the surface of the last, to determine and store cross-sectional images in layers, after which the cross-sectional images are used to determine typical fixed points or virtual points, which are based on the shape of the foot or last, and connecting lines which extend between said points and can run in the plane of the sectional images or else in any desired orientation with respect to the latter, or by an X-ray recording method whose summation pictures are used by an X-ray contrasting calibration element to measure the points of interest.

The advantage achieved by the invention essentially resides in the fact that the inner area of the shoe is scanned virtually in an unbroken manner, thus resulting in a complete image of the inner area of the shoe which can be subsequently used to derive any desired dimension and any desired line that is significant for the fit and/or shaping of the shoe. In this case, it is not only possible to measure the secants between the fixed points or virtual points, that is to say their shortest connection, but also to additionally take into account the fact that the connecting lines between the points often run in an arcuate manner since the lasts are generally produced with a certain contour which may be, for example, undulating, rounded or cambered. Just taking into account the arcuate profile of the connecting lines between the fixed points or—depending on the requirement—selected virtual points opens up additional possibilities which could not be achieved with the previous linearly operating measurement methods. In particular, it is possible to use known mathematical reconstruction methods to generate sectional images in any desired planes, with the result that it is possible to check the desired and actual dimensions to a degree of accuracy that has not been known to date.

Dimensioning the shoe at a particular height above the insole is often also decisive since, for example, the uppermost point of the heel often protrudes over the rear bounding edge of the insole. Depending on the make of the shoe, the inner length of the shoe may vary approximately 1 cm above the insole even though an insole of the same dimensions was used as a basis. In this respect too, the invention affords advantages since it makes it possible to determine these variables without any problems.

One preferred embodiment of the invention provides for the first fixed point or virtual point or else further fixed points or virtual points to be either interactively determined in a graphical reproduction device or to be automatically determined using an algorithm. This results, in particular, in the further advantageous possibility that, in order to mark the fixed points or virtual points, the graphical reproduction is optimized by setting brightness and contrast and the image reproduction is magnified, if necessary, which is advantageous, in particular, in the case of children's shoes.

It is also proposed, within the scope of the invention, to use a computer to determine the lengths of the connecting lines and/or the areas formed between selected connecting lines and/or the volumes enclosed by the areas. To this end, use is expediently made of suitable computer programs which, after the specification of fixed points or virtual points to be taken into account or else automatically, use the resulting inner contour lines to calculate the dimensions and variables to be determined.

In order to be able to use standard computation methods in this case, it is recommended to record the cross-sectional images parallel to the longitudinal axis of the foot. For the rest, it has proved to be expedient in this case to specify that the distance between the cross-sectional images is approximately 1 mm.

In order to use the method in practice, it is proposed, within the scope of the invention, to respectively use the end points of particular dimensions, in particular the length of the insole measured in the direction of the longitudinal axis of the foot as well as the length of the foot, and also the line of the ball of the foot, the line of maximum taper and the width of the heel as fixed points.

In addition, it has also proved to be expedient for the points at which particular lines intersect, in particular the point at which the line of the ball of the foot, the line of maximum taper and the width of the heel respectively intersect the longitudinal axis of the foot, to also be used as fixed points.

In order to achieve the clearest possible image of the interior of the foot, the shoe interior can be filled with air, water or another liquid or gaseous contrast agent which is suitable for the respective measurement method selected. If appropriate; smoke, vapor or the like may also be used for this purpose.

If contrast agents other than air are used, it is recommended for the contrast agent to be surrounded by an elastic, bubble-type enclosure which is applied to the inner area of the shoe with an accurate fit.

In order to be able to detect the dimensions of the shoe, in particular of a shoe that has been deformed by use, as accurately as possible, the invention may also provide for the contrast agent which fills the inner volume of the shoe to be pressurized. This additionally makes it possible to detect how the shoe behaves if more volume than the interior of the shoe is initially able to hold is introduced into the interior of the shoe.

### BRIEF DESCRIPTION OF THE DRAWINGS

The invention will be explained in more detail below with reference to the drawing, in which:

FIG. 1 shows a cross-sectional image of a shoe created using computer tomography,

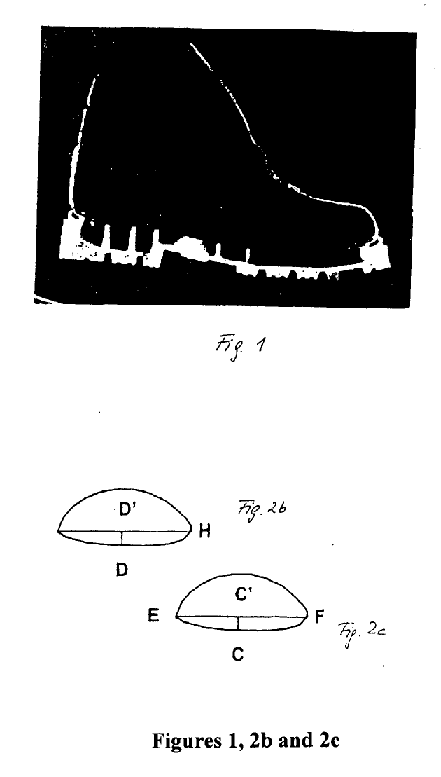

FIG. 2 shows a plan view of the insole having fixed points and connecting lines which represent the shape of the foot,

FIG. 3 shows a more complete reproduction of relevant shoe dimensions which goes beyond the values according to FIG. 2.

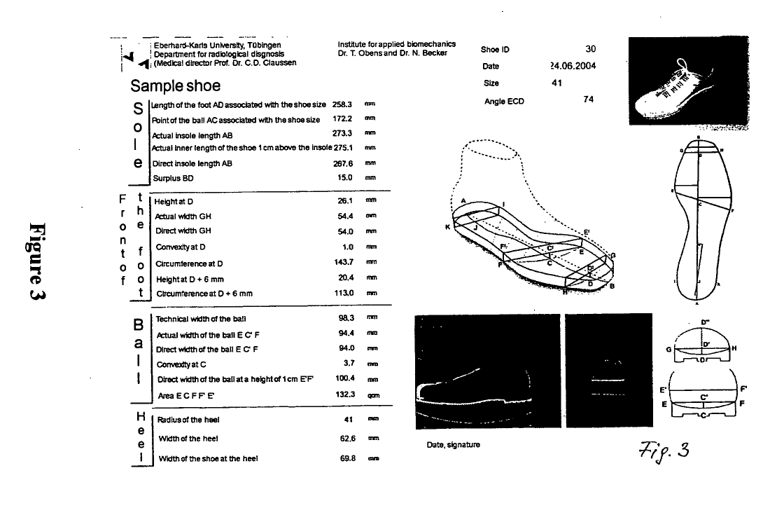

### MODES OF CARRYING OUT THE INVENTION

An examination method, as is also customary in radiological diagnosis, is proposed for the nondestructive determination of the inner dimensions of a shoe, boot or the like. In the case of computer tomography, an X-ray tube rotates around the object to be examined, the X-ray radiation which emerges behind the object and has been attenuated on the basis of the density values of the object that has been X-rayed being recorded by concomitantly rotating detector rings. This produces sectional images of a selectable layer thickness which can be subsequently managed, considered, post-processed and evaluated with the aid of a computer.

This method can also be used to determine the outer dimensions of a last that is used to make a shoe, in which case it is then possible, in particular, to compare the desired values prescribed by the last with the actual values which result after the shoe has been made.

In any case, a measuring arrangement, in which a radiological, computer tomographic, NMR tomographic or other imaging measurement method which penetrates the sole and upper and determines and stores cross-sectional images in layers is used, is essential for use. However, it is also possible, in principle, to use standard X-ray radiographs.

If the measurement is effected using a conventional X-ray radiograph, the entire shoe and/or last is recorded. These pictures represent summation pictures as regards the radiation power absorbed. The dimensions of interest such as length, width, circumference and areas can be determined from the generated image using the different densities and the different thickness of the materials. Calibration must be effected in order to evaluate the image, said calibration being able to be effected using an X-ray contrasting element of defined dimensions which has been inserted.

Finally, the method also makes it possible to compare or compensate for the last which is used to make the shoe and the actual last which is reconstructed from the interior of the shoe.

In a subsequent method step, these cross-sectional images are used to determine typical fixed points or virtual points which are based on the shape of the foot, connecting lines which extend between the fixed points or virtual points, run in a rectilinear or arcuate manner and can extend either in the plane of the sectional images or else obliquely or perpendicular to the latter also being able to be additionally determined.

A graphical reproduction device, which is not illustrated in the drawing and in which either the measured cross-sectional images themselves or else images which are derived from the latter using a mathematical reconstruction method and are orientated in any desired manner with respect to the originally recorded cross-sectional images can be reproduced, is particularly suitable for visually determining and marking the fixed points or virtual points.

This makes it possible, in particular, for the graphical reproduction to be influenced in order to mark the fixed points, the practice of varying and setting the brightness and contrast being particularly suitable for this purpose. In addition, the image reproduction can also be magnified, in particular in the case of small shoes.

During evaluation, it is then possible to use a computer to determine the lengths of the connecting lines and/or the areas formed between selected connecting lines or even the volumes enclosed by the areas.

In order to be able to use standard algorithms to evaluate the measurement results, the cross-sectional images are preferably recorded parallel to the longitudinal axis of the foot, for which purpose the shoe to be examined is positioned, using a fan laser, such that it is transverse to the longitudinal axis of the measuring device. In principle, however, the measurement method can also be used without previous alignment. Sufficient measurement accuracy is generally achieved if the distance between the cross-sectional images is approximately 1 mm.

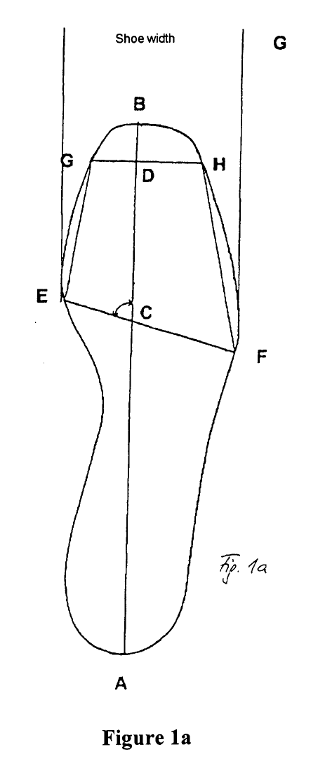

The end points of particular shoe dimensions are respectively used as fixed points. The length of the insole which is measured in the direction of the longitudinal axis of the foot and is labeled in FIG. 2 using the letters A-B is considered, in particular, for this purpose. The length of the foot corresponds to the distance between the points A and D and the line of the ball of the foot is denoted using the letters E-F. The line of maximum taper is denoted using the letters G-H.

The points at which particular lines intersect also play a role as fixed points: these are, in particular, the point at which the line of the ball of the foot and the longitudinal axis of the foot intersect (denoted using C in the drawing) and the point at which the line of maximum taper and the longitudinal axis of the foot intersect (denoted using the letter D in FIG. 2). This is an example of current insole templates. The evaluations may likewise be based on any other insole and shoe scheme.

In order to measure the inner dimensions of the shoe, the interior may be filled with air, water or another liquid or gaseous contrast agent that is suitable for the respective measurement method selected. If air is not used as the contrast agent, it is recommended for the contrast agent to be surrounded by an elastic and bubble-type enclosure which is applied to the inner area of the shoe with an accurate fit. This can be, for example, an elastomeric material such as latex.

It is then also possible, in particular, to pressurize the contrast agent which fills the inner volume of the shoe, thus ensuring, on the one hand, direct bearing contact with the inner wall of the shoe and, on the other hand, also making it possible to conduct examinations and measurements as regards the manner in which the shoe or shoe material behaves under the influence of pressure. This also makes it possible for shoes which have already been used and which have possibly also experienced deformation in the form of dents to be sometimes restored to the initial state.

As a result of these examinations, it is then possible, in the case of prized dimensions for the shoe, to adapt the last, so that the shoe which is then manufactured subsequently exactly corresponds to the prized dimensions. In principle, however, a multiplicity of further examinations are conceivable since the method provides an accurate image of the inner area of the shoe, which has not been able to be achieved to date, and thus affords more extensive possibilities that are used to achieve an optimum fit of the shoe.

In principle, it is possible to measure either the shoe and last separately from one another or else the shoe with the last. In addition, the human foot in the shoe can also be detected, preferably by means of NMR tomography (for example in different load situations). Its changes in different shoes and/or in comparison with the barefoot situation can also be assessed.

1. A method for the nondestructive determination of all or particular selected inner dimensions and/or outer dimensions of a shoe, boot or the like and/or the outer dimensions of a last that is used to make a shoe, characterized by a measuring arrangement which detects and/or images the inner area of the shoe and/or the surface of the last in three dimensions and is used by a radiological, computer tomographic, NMR tomographic or other imaging measurement method, which penetrates the sole and upper of the shoe and scans the surface of the last, to determine and store cross-sectional images in layers, after which the cross-sectional images are used to determine typical fixed points or virtual points, which are based on the shape of the foot, and connecting lines which extend between said points and can run in the plane of the sectional images or else in any desired orientation with respect to the latter, or by an X-ray recording method whose summation pictures are used by an X-ray contrasting calibration element to measure the points of interest.

2. The method as claimed in claim 1, wherein the first fixed point or virtual point or else further fixed points or virtual points is/are either interactively determined in a graphical reproduction device or is/are automatically determined using an algorithm.

3. The method as claimed in claim 2, wherein, in order to mark the fixed points or virtual points, the graphical reproduction is optimized by setting brightness and contrast and the image reproduction is magnified, if necessary.

4. The method as claimed in claim 1, wherein the lengths of the connecting lines and/or the areas formed between selected connecting lines and/or the volumes enclosed by the areas are determined using a computer.

5. The method as claimed in claim 1, wherein the cross-sectional images are recorded parallel to the longitudinal axis of the foot.

6. The method as claimed in claim 1, wherein the distance between the cross-sectional images is approximately 1 mm.

7. The method as claimed in claim 1, wherein the end points of particular dimensions, in particular the length of the insole measured in the direction of the longitudinal axis of the foot as well as the length of the foot, and also the line of the ball of the foot, the line of maximum taper and the width of the heel are respectively used as fixed points.

8. The method as claimed in claim 7, wherein the points at which particular lines intersect, in particular the point at which the line of the ball of the foot, the line of maximum taper and the width of the heel respectively intersect the longitudinal axis of the foot, are also used as fixed points or virtual points.

9. The method as claimed in claim 1, wherein the shoe interior is filled with air, water or another liquid or gaseous contrast agent which is suitable for the respective measurement method selected.

10. The method as claimed in claim 9, wherein the contrast agent is surrounded by an elastic, bubble-type enclosure which is applied to the inner area of the shoe with an accurate fit.

11. The method as claimed in claim 10, wherein the contrast agent which fills the inner volume of the shoe is pressurized.
